(19) United States
(12) Patent Application Publication
(10) Pub. No.: US 2026/0048993 A1
(43) Pub. Date: Feb. 19, 2026

(54) METHOD OF MAKING MOLECULAR SIEVES OF DON FRAMEWORK TYPE

(71) Applicant: EXXONMOBIL TECHNOLOGY AND ENGINEERING COMPANY, Spring, TX (US)

(72) Inventors: Trong D. PHAM, Flemington, NJ (US); Scott J. Weigel, Allentown, PA (US); Hilda B. Vroman, Piscataway, NJ (US); Joseph M. Falkowski, Hampton, NJ (US)

(21) Appl. No.: 19/299,668

(22) Filed: Aug. 14, 2025

Related U.S. Application Data
(60) Provisional application No. 63/683,197, filed on Aug. 14, 2024.

(51) Int. Cl. C01B 39/48

(52) U.S. Cl. CPC C01B 39/48; C01P 2002/72; C01P 2004/03; C01P 2004/54; C01P 2004/62; C01P 2004/64

(57) ABSTRACT

A method of making molecular sieves of DON framework type is provided. Molecular sieves of DON framework type are also provided, including molecular sieves of DON framework type having an aspect ratio (L/D) of at most 10 and/or small crystal forms of molecular sieves of DON framework type. Uses of molecular sieves of DON framework type are also provided.

### CROSS-REFERENCE TO RELATED APPLICATION

This non-provisional patent application claims priority to U.S. provisional patent app. No. 63/683,197, filed Aug. 14, 2024, and titled “METHOD OF MAKING MOLECULAR SIEVES OF DON FRAMEWORK TYPE,” the entire contents of which is incorporated herein by reference.

### TECHNICAL FIELD

The present disclosure relates to a method of making molecular sieves of DON framework type. The present disclosure also relates to molecular sieves of DON framework type having an aspect ratio (L/D) of at most 10, in particular to small crystal forms of molecular sieves of DON framework type, and uses thereof.

### BACKGROUND OF THE INVENTION

Molecular sieve materials, both natural and synthetic, may be used as adsorbents and have catalytic properties for hydrocarbon conversion reactions. Certain molecular sieves, such as zeolites, AlPOs, and mesoporous materials, are ordered, porous crystalline materials having a definite crystalline structure as determined by X-ray diffraction (XRD). Certain molecular sieves are ordered and produce specific identifiable XRD patterns. Within certain molecular sieve materials there may be a large number of cavities, which may be interconnected by a number of channels or pores. These cavities and pores are uniform in size within a specific molecular sieve material. Because the dimensions of these pores are such as to accept for adsorption molecules of certain dimensions while rejecting those of larger dimensions, these materials have come to be known as “molecular sieves” and are utilized in a variety of industrial processes, e.g., cracking, hydrocracking, disproportionation, alkylation, oligomerization, and isomerization.

Molecular sieves that find application in catalysis and adsorption include any of the naturally occurring or synthetic crystalline molecular sieves. These zeolites and their isotypes are classified by the Structure Commission of the International Zeolite Association according to the rules of the IUPAC Commission on Zeolite Nomenclature. According to this classification, framework type zeolites and other crystalline microporous molecular sieves, for which a structure has been established, are assigned a three letter code and are described in the “Atlas of Zeolite Framework Types”, eds. Ch. Baerlocher, L. B. McCusker, and D. H. Olson, Elsevier, Sixth Edition, 2007, which is hereby incorporated by reference. These zeolites and their isotypes are also described in http://america.iza-structure.org/IZA-SC/ftc_table.php.

The idealized inorganic framework structure of zeolites is a framework of silicate in which all tetrahedral atoms are connected by oxygen atoms with the four next-nearest tetrahedral atoms. The term “silicate”, as used herein, refers to a substance containing at least silicon and oxygen atoms that are alternately bonded to each other (i.e., —O—Si—O—Si—), and optionally including other atoms within the inorganic framework structure, including atoms such as boron, aluminum, or other metals (e.g., transition metals, such as titanium, vanadium, or zinc). Atoms other than silicon and oxygen in the framework silicate occupy a portion of the lattice sites otherwise occupied by silicon atoms in an ‘all-silica’ framework silicate. Thus, the term “framework silicate” as used herein refers to an atomic lattice comprising any of a silicate, borosilicate, gallosilicate, ferrisilicate, aluminosilicate, titanosilicate, zincosilicate, vanadosilicate, or the like.

The structure of the framework silicate within a given zeolite determines the size of the pores or channels that are present therein. The pore or channel size may determine the types of processes for which a given zeolite is applicable. Currently, greater than 200 unique zeolite framework silicate structures are known and recognized by the Structure Commission of the International Zeolite Association, thereby defining a range of pore geometries and orientations.

The framework silicates of zeolites or molecular sieves are commonly characterized in terms of their ring size, wherein the ring size refers to the number of silicon atoms (or alternative atoms, such as those listed above) that are tetrahedrally coordinated with oxygen atoms in a loop to define a pore or channel within the interior of the zeolite. For example, an “8-ring” zeolite refers to a zeolite having pores or channels defined by 8 alternating tetrahedral atoms and 8 oxygen atoms in a loop. The pores or channels defined within a given zeolite may be symmetrical or asymmetrical depending upon various structural constrains that are present in the particular framework silicate.

Zeolites can be classified as having small, medium, large, and extra-large pore structures for pore windows delimited by 8, 10, 12, and more than 12 T-atoms, respectively. Extra-large pore zeolites (>12 R) include, for example, AET (14 R, e.g., ALPO-8), SFN (14 R, e.g., SSZ-59), DON (14 R, e.g., UTD-1), VFI (18 R, e.g., VPI-5), CLO (20 R, e.g., cloverite), and ITV (30 R, e.g., ITQ-37) framework type zeolites. Extra-large pore zeolites generally have a free pore diameter of larger than about 0.8 nm. Large pore zeolites (12 R) include, for example, LTL, MAZ, FAU, EMT, OFF, MTW, *BEA, MOR, and SFS framework type zeolites, e.g., mazzite, offretite, zeolite

L, zeolite Y, zeolite X, omega, ZSM-2, ZSM-12, zeolite T, Beta, and SSZ-56. Large pore zeolites generally have a free pore diameter of 0.6 to 0.8 nm. Medium (or intermediate) pore size zeolites (10 R) include, for example, MFI, MEL, *MRE, EUO, MTT, MFS, AEL, AFO, HEU, FER, MWW, and TON framework type zeolites, e.g., ZSM-5, ZSM-11, ZSM-48, ZSM-22, ZSM-23, ZSM-35, MCM-22, silicalite-1, and silicalite-2. Medium pore size zeolites generally have a free pore diameter of 0.45 to 0.6 nm. Small pore size zeolites (8 R) include, for example, CHA, RTH, ERI, KFI, LEV, and LTA framework type zeolites, e.g., ZK-4, SAPO-34, SAPO-35, ZK-14, SAPO-42, ZK-21, ZK-22, ZK-5, ZK-20, zeolite A, chabazite, and ALPO-17. Small pore size zeolites generally have a free pore diameter of 0.3 to 0.45 nm.

Synthesis of molecular sieve materials typically involves hydrothermal crystallization from a synthesis mixture comprising sources of all the elements present in the molecular sieve (or zeolite) such as sources of silica but also of alumina etc. In many cases a structure directing agent (SDA) is also present. Structure directing agents are compounds which are believed to promote the formation of molecular sieves and which are thought to act as templates around which certain molecular sieve structures can form and which thereby promote the formation of the desired molecular sieve. Various compounds have been used as structure directing agents including various types of quaternary ammonium cations. Typically, molecular sieve (or zeolite) crystals form around structure directing agents with the structure directing agent occupying pores in the molecular sieve once crystallization is complete. The “as-synthesized” (or “as-made”) molecular sieve will therefore contain the structure directing agent in its pores so that, following crystallization, the “as-synthesized” molecular sieve is usually subjected to a treatment step such as a calcination step to remove the structure directing agent.

UTD-1 is a one-dimensional, extra-large pore silicate-based zeolite with 14-ring pore system. Although UTD-1 is typically a disordered structure, one ordered polytype of UTD-1 is recognized as having a DON framework by the Structure Commission of the International Zeolite Association (http://america.iza-structure.org/IZA-SC/ftc_table.php). UTD-1 was originally synthesized as all-silica, aluminosilicate or borosilicate forms using cobalticinium ions as structure directing agents, resulting in UTD-1 crystals in the form of long platelike crystals with approximate dimensions of 1 by 5 microns or of bundles of well-formed but very fine needle-like crystallites with dimensions of about 0.5 by 0.5 by 40 microns (see U.S. Pat. No. 5,489,424A; US6, 103,215A; Lobo et al., J. Am. Chem. Soc., 1997, 119, 8474-8484; T. Wessels et al., J. Am. Chem. Soc., 1999, 121, 6242-6247). Later on, it was found that silicate molecular sieves of UTD-1 structure, including all-silica, aluminosilicate, borosilicate or titanosilicate forms, could be prepared under hydrothermal synthesis conditions using organic structure directing such agents as 1,2,3-trimethylbenzimidazolium (see W. Zi et al., Microporous and Mesoporous Materials, 2019, 290, 109654, 1-6; CN107892309B; WO2020/072157A1). Resulting UTD-1 crystals were in the form of needles or laths or stick-like or rod-like crystals, possibly in the form of bundles thereof, said crystals having a length of approximately 0.25 to 0.50 micron, or even as long as 1 micron or higher, and an aspect ratio (L/D) higher than 10.

Crystals having an aspect ratio (L/D) higher than 10, such as needles, sticks, laths, rods or fibrous crystals, have produced concern as to the health effects of inhalation over a long period of time. It would thus be advantageous to produce molecular sieves of DON framework type having a different morphology, in particular an aspect ratio (L/D) of at most 10 and preferably lower than 10, and most advantageously small crystal forms of such molecular sieves. It is also important to identify more efficient methods for the synthesis of molecular sieves to facilitate their preparation and/or to reduce associated costs.

### SUMMARY

In a first aspect, the present disclosure relates to a method of making a molecular sieve of DON framework type comprising the following steps:
(a) preparing a synthesis mixture comprising water, a source of an oxide of tetravalent element (Y), a source of an oxide of trivalent element (X), a structure directing agent (Q) selected from 1,2,3-trimethylbenzimidazolium cations, a source of hydroxide ions (OH), and a source of alkali and/or alkaline earth metal element (M), wherein the synthesis mixture comprises water in a H₂O:Y molar ratio of less than 45;
(b) heating said synthesis mixture under crystallization conditions including a temperature of from 100 to 200° C. for a time sufficient to form crystals of said molecular sieve;
(c) recovering at least a portion of the molecular sieve from step (b); and
(d) optionally treating the molecular sieve recovered in step (c) to remove at least part of the structure directing agent (Q).

In a second aspect, the present disclosure relates to a molecular sieve of DON framework type obtainable by the method of the present disclosure.

In a third aspect, the present disclosure relates to a molecular sieve of DON framework type having an aspect ratio (L/D) of at most 10.

In a fourth aspect, the present disclosure relates to a molecular sieve of DON framework type having a maximal particle size and/or an average maximal particle size of less than 250 nm, as determined by scanning electron microscopy (SEM).

In a fifth aspect, the present disclosure relates to a process of converting an organic compound to a conversion product, which comprises contacting the organic compound with the molecular sieve of the present disclosure or obtained by the method of the present disclosure.

These and other features and attributes of the present disclosure and their advantageous applications and/or uses will be apparent from the detailed description which follows. It will of course be appreciated that features described in relation to one aspect of the present invention may be incorporated into other aspects of the present invention. In particular, any two or more of the features described in this specification, including in this summary section, can be combined to form combinations of features not specifically described herein.

### DESCRIPTION OF THE DRAWINGS

FIG. 1 shows the powder XRD pattern of the as-synthesized product of Example 1a.

FIG. 2 shows SEM images of the as-synthesized product of Example 1a.

FIG. 3 shows a SEM image of the as-synthesized product of Example 1b.

FIG. 4 shows SEM images of the as-synthesized product of Example 2.

FIG. 5 shows SEM images of the as-synthesized product of Example 4.

FIG. 6 shows SEM images of the as-synthesized product of Example 9.

FIG. 7 shows a SEM image of the as-synthesized product of Example 10.

FIG. 8 shows SEM images of the as-synthesized product of Example 11.

FIG. 9 shows SEM images of the as-synthesized product of Example 13.

FIG. 10 shows SEM images of the as-synthesized product of Comparative Example 14.

FIG. 11 shows SEM images of the as-synthesized product of Comparative Example 17.

FIG. 12 shows the powder XRD pattern of the as-synthesized product of Example 18.

FIG. 13 shows SEM images of the as-synthesized product of Example 18.

FIG. 14 shows molar ratios and conditions used for the syntheses of Examples 1a, 1b, and 2-9.

FIG. 15 shows molar ratios and conditions used for the syntheses of Examples 10-18.

### DETAILED DESCRIPTION

The present disclosure relates to a method of making molecular sieves of DON framework type. The present disclosure also relates to molecular sieves of DON framework type having an aspect ratio (L/D) of at most 10, in particular small crystal forms of molecular sieves of DON framework type, and uses thereof. Said molecular sieves may be designated as UTD-1 or EMM-57 molecular sieves, or UTD-1 or EMM-57 zeolites, or UTD-1 or EMM-57 materials.

In a first aspect, the present disclosure relates to a method of making a molecular sieve of DON framework type comprising the following steps:
(a) preparing a synthesis mixture comprising water, a source of an oxide of tetravalent element (Y), a source of an oxide of trivalent element (X), a structure directing agent (Q) selected from 1,2,3-trimethylbenzimidazolium cations, a source of hydroxide ions (OH), and a source of alkali and/or alkaline earth metal element (M), wherein the synthesis mixture comprises water in a H₂O:Y molar ratio of less than 45;
(b) heating said synthesis mixture under crystallization conditions including a temperature of from 100 to 200° C. for a time sufficient to form crystals of said molecular sieve;
(c) recovering at least a portion of the molecular sieve from step (b); and
(d) optionally treating the molecular sieve recovered in step (c) to remove at least part of the structure directing agent (Q).

The structure directing agent (Q) is selected from 1,2,3-trimethylbenzimidazolium cations, i.e., from cations of the following structure:

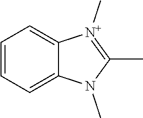

The structure directing agent (Q) may be present in any suitable form, for example as a halide, such as a fluoride, a chloride, an iodide or a bromide, as a hydroxide or as a nitrate, for instance in its hydroxide form. The structure directing agent (Q) may be present in the synthesis mixture in a Q/Y molar ratio of from 0.01 to 1.0, such as from 0.05 to 0.5, advantageously from 0.05 or from 0.1 to less than 0.3 or to less than 0.2, e.g., 0.1, 0.125 or 0.15.

The synthesis mixture comprises at least one source of an oxide of tetravalent element Y which may be selected from the group consisting of Si, Ge, Sn, Ti, Zr, and mixtures thereof, preferably Y comprises Si and/or Ge, e.g., Si, and more preferably Y is Si and/or Ge, e.g., Si. Suitable sources of tetravalent element Y that can be used to prepare the synthesis mixture depend on the element Y that is selected. In embodiments where Y is silicon, Si sources (e.g., silicon oxide sources) suitable for use in the method include silicates, e.g., tetraalkyl orthosilicates such as tetramethylorthosilicate (TMOS) and tetraethylorthosilicate (TEOS), fumed silica such as Aerosil® (available from Evonik), Cabosperse® (available from Cabot) and CabO-O-Sil® (available from DMS), precipitated silica such as Ultrasil® and Sipernat® 340 (available from Evonik) or Hi-Sil®, alkali metal silicates such as potassium silicate and sodium silicate, and aqueous colloidal suspensions of silica, for example, that sold by Grace under the tradename Ludox® or that sold by Evonik under the tradename Aerodisp®; in particular fumed silica, colloidal silica, and precipitated silica. In embodiments where Y is germanium, suitable Ge sources include germanium oxide. In embodiments where Y is titanium, suitable Ti sources include titanium dioxide and titanium tetraalkoxides, such as titanium (IV) tetraethoxide and titanium (IV) tetrachloride. In embodiments where Y is tin, suitable Sn sources include tin chloride and tin alkoxides, such as tin ethoxide and tin isopropoxide. In embodiments where Y is zirconium, suitable Zr sources include zirconium chloride and zirconium alkoxides, such as zirconium ethoxide and zirconium isopropoxide.

The synthesis mixture comprises at least one source of an oxide of trivalent clement X which may be selected from the group consisting of Al, B, Fe, Ga, and mixtures thereof, preferably X comprises Al and/or B, e.g., Al, and more preferably X is Al and/or B, e.g., Al. Suitable sources of trivalent clement X that can be used to prepare the synthesis mixture depend on the element X that is selected. In embodiments where X is aluminum, Al sources (e.g., aluminum oxide sources) suitable for use in the method include aluminum hydroxide, aluminum salts, especially water-soluble salts, such as aluminum sulfate, aluminum nitrate, alkali metal aluminates such as sodium or potassium aluminate, and aluminum alkoxides such as aluminum isopropoxide, as well as hydrated aluminum oxides, such as boehmite, gibbsite, and pseudoboehmite, and mixtures thereof. Other aluminum sources include, but are not limited to, other water-soluble aluminum salts, or aluminum metal, such as aluminum in the form of chips. Especially suitable sources of alumina are aluminum hydroxide and water-soluble salts, such as aluminum sulfate, aluminum nitrate, and alkali metal aluminates such as sodium aluminate and potassium aluminate. In embodiments where X is boron, suitable B sources include boric acid and borate salts such as sodium tetraborate or borax and potassium tetraborate. Sources of boron tend to be more soluble than sources of aluminum in hydroxide-mediated synthesis systems. In embodiments where X is gallium, suitable Ga sources include sodium gallate, potassium gallate, and gallium salts such as gallium chloride, gallium sulfate, and gallium nitrate. In embodiments where X is iron, suitable Fe sources include iron chloride, iron nitrate, and iron oxides.

Alternatively or in addition to previously mentioned sources of Y and X, sources containing both Y and X elements can also be used, such as sources of Si and Al. Examples of suitable sources containing both Si and Al elements include amorphous silica-alumina gels or dried silica alumina powders, silica aluminas, clays, such as kaolin, metakaolin, and zeolites, in particular aluminosilicates such as synthetic faujasite and ultrastable faujasite, for instance Y-Type Zeolite, Ultrastable Y (USY), beta or other large to medium pore molecular sieves or zeolites. Aluminosilicates such as synthetic faujasite and ultrastable faujasite are especially suitable sources of Si and Al.

The synthesis mixture may have a Y/X molar ratio of from 5 to 100, in particular from 7.5 to 100 or from 10 to 70, e.g., from 10 to 50 or from 15 to 30.

In preferred embodiment of this aspect of the invention, Y is Si, X is Al and/or B, and the molecular sieve is an aluminosilicate, a borosilicate, or an aluminoborosilicate.

The synthesis mixture comprises at least one source of hydroxide ions (OH). For example, hydroxide ions can be present as a counter ion of the structure directing agent (Q) or by the use of aluminum hydroxide or sodium aluminate as a source of Al. Suitable sources of hydroxide ions can also be selected from the group consisting of alkali metal hydroxides, alkaline earth metal hydroxides, ammonium hydroxide, and mixtures thereof; such as from sodium hydroxide, potassium hydroxide, lithium hydroxide, rubidium hydroxide, calcium hydroxide, magnesium hydroxide, ammonium hydroxide, and mixtures thereof; more often sodium hydroxide, potassium hydroxide, lithium hydroxide, ammonium hydroxide, and mixtures thereof; most often sodium hydroxide, lithium hydroxide and/or potassium hydroxide. The synthesis mixture may comprise the hydroxide ions source in an OH/Y molar ratio of from 0.01 to 1.0, such as from 0.05 to 0.8, for instance from 0.1 to 0.5 or from 0.2 to 0.4, e.g., from 0.15 to 0.3.

The synthesis mixture comprises one or more sources of alkali or alkaline earth metal cation (M). M is preferably selected from the group consisting of sodium, potassium, lithium, rubidium, cesium, calcium, magnesium, strontium, barium, and mixtures thereof, preferably sodium, lithium and/or potassium, e.g., potassium. In embodiments where M is sodium, suitable sodium sources include sodium hydroxide, sodium aluminate, sodium silicate, or sodium salts such as NaCl, NaBr or sodium nitrate. In embodiments where M is potassium, suitable potassium sources include potassium hydroxide, potassium aluminate, potassium silicate, a potassium salt such as KCl or KBr or potassium nitrate. In embodiments where M is lithium, suitable lithium sources include lithium hydroxide or lithium salts such as LiCl, LiBr, LiI, lithium nitrate, or lithium sulfate. In embodiments where M is rubidium, suitable rubidium sources include rubidium hydroxide or rubidium salts such as RbCL, RbBr, RbI, or rubidium nitrate. In embodiments where M is cesium, suitable cesium sources include cesium hydroxide. In embodiments where M is calcium, suitable calcium sources include calcium hydroxide. In embodiments where M is magnesium, suitable magnesium sources include magnesium hydroxide. In embodiments where M is strontium, suitable strontium source include strontium hydroxide. In embodiments where M is barium, suitable barium source include barium hydroxide. The alkali or alkaline earth metal cation M may also be present in the one or more sources of a trivalent element X, such as sodium aluminate, potassium aluminate, sodium tetraborate, potassium tetraborate, sodium gallate, potassium gallate, and/or in the one or more sources of tetravalent element Y, such as potassium silicate and/or sodium silicate. The source of alkali or alkaline earth metal cation (M) is advantageously soluble in water. The synthesis mixture may comprise the alkali or alkaline earth metal cation (M) source in a M/Y molar ratio of from 0.01 to 1.0, such as from 0.02 to 0.5, for instance from 0.03 to 0.3 or from 0.05 to 0.2, e.g., 0.05, 0.1 or 0.15.

The synthesis mixture may optionally contain at least one source of halide ions (W) which may be selected from the group consisting of fluoride, chloride, bromide or iodide. The source of halide ions (W) may be any compound capable of releasing halide ions in the molecular sieve synthesis mixture. For instance, halide ions can be present as a counter ion of the structure directing agent (Q). Non-limiting examples of sources of halide ions include hydrogen fluoride, ammonium fluoride (NH₄F), ammonium bifluoride (NH₄HF₂), hydrogen chloride, ammonium chloride, hydrogen bromide, ammonium bromide, hydrogen iodide, and ammonium iodide; salts containing one or several halide ions, such as metal halides, preferably where the metal is an alkali or alkaline earth metal such as sodium, potassium, calcium, magnesium, strontium or barium, or a metal such as (AlF₃, Al₂F6) or tin (SnF₂); or tetraalkylammonium halides such as tetramethylammonium halides or tetraethylammonium halides. Small amounts of halide ions (W) may also be present as impurities, for instance in the source of alkali or alkaline earth metal cation (M). The halide ions (W) may be present in a W/Y molar ratio of 0 to 0.2, such as 0 to 0.1, for instance less than 0.1 or even 0. Alternatively, the synthesis mixture may be substantially free from halide ions (W).

The synthesis may be performed with or without added nucleating seeds. If nucleating seeds are added to the synthesis mixture, the seeds may be of the same or of a different structure than the molecular sieve of DON framework type of the present disclosure, preferably seeds of DON framework type, for instance molecular sieves obtained from a previous synthesis. Nucleating seeds may suitably present in an amount from about 0.01 ppm by weight to about 20,000 ppm by weight, based on the synthesis mixture, such as from about 100 ppm by weight to about 10,000 ppm by weight of the synthesis mixture, such as about 1 to 2 wt % of the synthesis mixture.

The synthesis mixture comprises water in a H₂O/Y molar ratio of less than 45, in particular of from 1 to less than 45, such as from 5 to 40 or from 10 to 30, e.g., from 15 to 30. Depending on the nature of the components in the base mixture, the amount of solvent (e.g., water from the hydroxide solution, and optionally methanol and ethanol from the hydrolysis of silica sources) of the base mixture may be removed such that a desired solvent (or H₂O) to Y molar ratio is achieved for the synthesis mixture. Suitable methods for reducing the solvent content may include evaporation under a static or flowing atmosphere such as ambient air, dry nitrogen, dry air, or by spray drying or freeze drying. Water may also be added to the resulting mixture to achieve the desired H₂O/Y molar ratio when too much water is removed during the solvent removal process. In some examples, water removal is not necessary when the preparation have sufficient H₂O/Y molar ratio.

Suitable synthesis mixture compositions, in terms of molar ratios, are illustrated in the table below:

| Molar ratios | Typical range | Preferred range | More preferred range |
|---|---|---|---|
| Y/X | 5-100 | 10-100 | 10-50 |
| Q/Y | 0.01-1.0 | 0.05-0.5 | 0.1-<0.3 |
| OH/Y | 0.01-1.0 | 0.05-0.8 | 0.1-0.5 |
| M/Y | 0.01-1.0 | 0.02-0.5 | 0.03-0.3 |
| H₂O/Y | 1-<45 | 5-40 | 10-30 |

Carbon in the form of CH₂ may be present in the various sources of components used to prepare the synthesis mixture of the present disclosure, e.g., tetravalent element source (e.g., silica source) or trivalent element source (e.g., alumina source), and incorporated into the resulting molecular sieve framework as bridging atoms. Nitrogen atoms may be incorporated into the framework of the molecular sieve material as bridging atoms after the SDA has been removed.

In one or more aspects, the synthesis mixture after solvent adjustment (e.g., where the desired water to silica ratio is achieved) may be mixed by a mechanical process such as stirring or high shear blending to assure suitable homogenization of the base mixture, for example, using dual asymmetric centrifugal mixing (e.g., a FlackTek speedmixer) with a mixing speed of 1000 to 3000 rpm (e.g., 2000 rpm).

The synthesis mixture is then subject to crystallization conditions suitable for the molecular sieve material to form. Crystallization of the molecular sieve material may be carried out under static or stirred conditions in a suitable reactor vessel, such as for example Teflon® lined or stainless-steel autoclaves placed in a convection oven maintained at an appropriate temperature.

The crystallization in step (b) of the method is typically carried out at a temperature of 100° C. to 200° C., such as 120° C. to 180° C., preferably 150° C. to 170° C., e.g., 160° C. or 170° C., for a time sufficient for crystallization to occur at the temperature used. For instance, at higher temperatures, the crystallization time may be reduced. For instance, the crystallization conditions in step (b) of the method may include heating for a period of from 1 to 100 days, such as from 1 to 50 days, for example from 1 to 30 days, e.g., at least 1 or at least 5 days up to 10 days. The crystallization time can be established by methods known in the art such as by sampling the synthesis mixture at various times and determining the yield and X-ray crystallinity of precipitated solid. Unless indicated otherwise herein, the temperature measured is the temperature of the surrounding environment of the material being heated, for example the temperature of the atmosphere in which the material is heated.

Typically, the molecular sieve is formed in solution and can be recovered by standard means, such as by centrifugation or filtration. The separated molecular sieve can also be washed, recovered by centrifugation or filtration and dried.

The molecular sieve of the present disclosure, when employed either as an adsorbent or as a catalyst in an organic compound conversion process may be dehydrated (e.g., dried) at least partially. This can be done by heating to a temperature in the range of 80° C. to 500° C., such as 90° C. to 370° C. in an atmosphere such as air, nitrogen, etc., and at atmospheric, subatmospheric or superatmospheric pressures for between 30 minutes and 48 hours. Dehydration may also be performed at room temperature merely by placing the molecular sieve in a vacuum, but a longer time is required to obtain a sufficient amount of dehydration.

As a result of the crystallization process, the recovered product contains within its pores at least a portion of the structure directing agent used in the synthesis. The as-synthesized molecular sieve recovered from step (c) may thus be subjected to thermal treatment or other treatment to remove part or all of the SDA incorporated into its pores during the synthesis. Thermal treatment (e.g., calcination) of the as-synthesized molecular sieve typically exposes the materials to high temperatures sufficient to remove part or all of the SDA, in an atmosphere selected from air, nitrogen, ozone or a mixture thereof in a furnace. While subatmospheric pressure may be employed for the thermal treatment, atmospheric pressure is desired for reasons of convenience. The thermal treatment may be performed at a temperature up to 925° C. e.g., 300° C. to 700° C. or 400 to 600° C.

The temperature measured is the temperature of the surrounding environment of the sample. The thermal treatment (e.g., calcination) may be carried out in a box furnace in dry air, which has been exposed to a drying tube containing drying agents that remove water from the air. The material is usually calcined for at least 1 minute and generally no longer than 1 or at most a few days. The heating may first be carried out under a nitrogen atmosphere and then the atmosphere may be switched to air and/or ozone.

The molecular sieve may also be subjected to an ion-exchange treatment, for example, with aqueous ammonium salts, such as ammonium nitrates, ammonium chlorides, and ammonium acetates, in order to remove remaining alkali metal cations and/or alkaline earth metal cations, if present in the synthesis mixture, and to replace them with protons thereby producing the acid form of the molecular sieve. To the extent desired, the original cations of the as-synthesized material, such as alkali metal cations, can be replaced by ion exchange with other cations. Preferred replacing cations can include hydrogen ions, hydrogen precursor, e.g., ammonium ions and mixtures thereof. The ion exchange step may take place after the as-made molecular sieve is dried. The ion-exchange step may take place either before or after a calcination step.

Optionally, aluminum atoms may be introduced in the molecular sieve framework (wherein part or all of the SDA has been removed) during an exchange process following the hydrothermal synthesis reaction. Framework silicates comprising boron atoms (e.g., borosilicates) may be particularly efficacious for undergoing exchange with aluminum atoms. Such exchange process may comprise exposing the molecular sieve to an aluminum source such as an aqueous solution comprising an aluminum salt, under conditions sufficient to exchange at least a portion and up to substantially all of the boron atoms in the framework silicate with aluminum atoms. For example, a calcined molecular sieve comprising boron may be converted to an aluminosilicate molecular sieve by heating the calcined molecular sieve comprising boron with a solution of aluminum sulfate, aluminum nitrate, aluminum chloride and/or aluminum acetate (e.g., in a sealed autoclave in a convention oven at 100° C. or at boiling temperature in an open system). The aluminum treated molecular sieve may then be recovered by filtration and washed with deionized water.

The molecular sieve may also be subjected to other treatments such as steaming and/or washing with solvent. Such treatments are well-known to the skilled person and are carried out in order to modify the properties of the molecular sieve as desired.

The method of the present disclosure is especially advantageous in that it allows the preparation of molecular sieves of DON framework type, such as UTD-1 or EMM-57 materials, in the form of crystals having an aspect ratio (L/D) of at most 10, preferably lower than 10, and/or in the form of crystals of small particle size, such as crystals having a maximal particle size and/or an average maximal particle size of less than 250 nm, such as less than 200 nm. Without wishing to be bound by theory, it has been found that this was made possible by running the synthesis in the presence of an alkali and/or alkaline earth metal element (M) and in the presence of water in a H₂O:Y molar ratio of less than 45. When these conditions are not met, for instance in the absence of alkali and/or alkaline earth metal element (M) and/or in the presence of water in a H₂O:Y molar ratio of 45 or higher, crystals of molecular sieves of DON framework type having aspect ratios (L/D) higher than 10 and/or bigger particle sizes are obtained. Materials having an aspect ratio (L/D) of at most 10, preferably lower than 10, are advantageous over materials in the form of needles, sticks, laths, rods or fibrous crystals having an aspect ratio (L/D) higher than 10 that have produced concern as to the health effects of inhalation over a long period of time. Also, needle-like morphologies (or more generally morphologies with aspect ratios >10) has never been the most favorable morphology for catalytic applications due to the low diffusion rate via the long needles, which usually led to coking and side reactions (by products). Small particle size (or crystal size or crystallite size) is also advantageous in catalysis and adsorption applications as it allows for faster diffusion rates and higher surface areas.

The method of the present disclosure is also advantageously conducted in the presence of small amounts of structure directing agent (Q), such as a Q/Y molar ratio of less than 0.3, or even less than 0.2. This is advantageous as a lower amount of SDA results in a more cost effective process. It is also advantageous because SDAs typically decompose at least partly in the synthesis mixture, so a lower amount of SDA will result in a lower amount of waste treatment. Last but not least, without wishing to be bound by theory, it is believed that, in the context of the present disclosure, a higher amount of SDA could result in pi-stacking of the SDA inside the 14 R channels which would favor long needle or stick morphology with aspect ratios (L/D) higher than 10. To the contrary, low SDA concentrations, such as Q/Y molar ratios of less than 0.3, or even less than 0.2, in particular low SDA concentration relative to alkali and/or alkaline earth metal cations (M) such as Q/M molar ratios of less than 4, such as from 0.5 to 3, e.g., 1 or 2, would result in breakage of the pi-stacking of the SDA molecules thus stopping the molecular sieve from growing along the 14 R channels (or along the needle or stick direction). Small amounts of SDA and in particular a

Q/M molar ratio of less than 4 may therefore also contribute to the preparation of crystals having a shorter aspect ratio (L/D) and/or a smaller particle size.

In a second aspect, the present disclosure relates to a molecular sieve of DON framework type, in particular UTD-1 or EMM-57 materials, obtainable by (or obtained by) the method of the first aspect disclosed herein.

In its as-synthesized form (e.g., where the SDA has not been removed), the molecular sieve material of the second aspect of the present disclosure may be represented, by the molecular formula of Formula I:

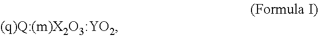

wherein 0<q≤1.0, 0.005<m≤0.1, X is a trivalent element, Y is a tetravalent element, and Q is selected from 1,2,3-trimethylbenzimidazolium cations. Y may comprise one or more of Si, Ge, Sn, Ti and Zr, for example Y may comprise or be Si. X may comprise one or more of Al, B, Fe and Ga, in particular X may comprise or be Al and/or B, for example X may comprise or be Al. In preferred embodiment of this aspect of the invention, Y is Si, X is Al and/or B, and the molecular sieve is an aluminosilicate, a borosilicate, or an aluminoborosilicate. The oxygen atoms in Formula I may be replaced by carbon atoms (e.g., in the form of CH₂), which can come from sources of the components used to prepare the as-made molecular sieve. The oxygen atoms in Formula I can also be replaced by nitrogen atoms, e.g., after the SDA has been removed. Formula I can represent the framework of a typical molecular sieve material having structure directing agent (Q) within its pore structure and is not meant to be the sole representation of such material. The molecular sieve may contain impurities which are not accounted for in Formula I. Further, Formula I does not include the protons and charge compensating ions that may be present in the molecular sieve material.

The variable m represents the molar ratio relationship of X₂O₃ to YO₂ in Formula I. For example, when m is 0.01, the molar ratio of YO₂ to X₂O₃ (or SiO₂ to Al₂O₃) is 100 and the Y/X (or Si/Al) molar ratio is 50. m may vary from 0.005 to 0.1, in particular from 0.005 to 0.067 or from 0.007 to 0.05, e.g., from 0.01 to 0.05 or from 0.017 to 0.03. The molar ratio of Y to X may be 5 to 100, in particular from 7.5 to 100 or from 10 to 70, e.g., 10 to 50 or 15 to 30.

The variable q represents the molar relationship of Q to YO₂ in Formula I. For example, when q is 0.1, the Q/Y molar ratio is 0.1. The molar ratio of Q to YO2 may be from 0 to 1.0, such as from 0.01 to 1.0, or from 0.05 to less than 0.3, or from 0.05 or 0.1 to less than 0.2, e.g., 0.1, 0.125 or 0.15.

In its calcined form (e.g., where at least part of the SDA has been removed via thermal treatment or other treatment), the molecular sieve material of the second aspect of the present disclosure may be represented, by the molecular formula of Formula II:

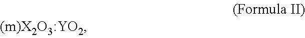

wherein 0.005<m≤0.1, X is a trivalent element as defined for Formula I and Y is a tetravalent clement as defined for Formula I. The oxygen atoms in Formula II may be replaced by carbon atoms (e.g., in the form of CH₂), which can come from sources of the components used to prepare the as-made molecular sieve. The oxygen atoms in Formula II can also be replaced by nitrogen atoms, e.g., after the SDA has been removed. Formula II can represent the framework of a typical molecular sieve as defined in the present disclosure, in its calcined form, and is not meant to be the sole representation of said molecular sieve. Said molecular sieve, in its calcined form, may contain SDA and/or impurities after appropriate treatments to remove the SDA and impurities, which are not accounted for in Formula II. Further, Formula II does not include the protons and charge compensating ions that may be present in the calcined molecular sieve. The variable m represents the molar ratio relationship of X₂O₃ to YO₂ in Formula II. The values for variable m in Formula II are the same as those described herein for Formula I.

The molecular sieve of the present disclosure, e.g., UTD-1 or EMM-57 materials,

whether in as-synthesized or calcined form, may have a Y/X molar ratio of up to 100, such as 5 to 100, for instance 7.5 to 100 or 10 to 70, e.g., 10 to 50 or 15 to 30, as determined by ICP elemental analysis.

Advantageously, at least a portion of the molecular sieve crystals of the present disclosure, whether in as-synthesized or calcined form, in particular the molecular sieve of the second aspect of the present disclosure, may have an aspect ratio (L/D) of at most 10, in particular less than 10, more particularly less than 8, such as from 1 to 6 or from 2 to 5, e.g., about 1, 2, 3 or 4. By “at least a portion” is meant at least about 50% of the molecular sieve particles (or crystals), such as at least 60%, at least 75%, or at least 85%. The aspect ratio (L/D) of a crystal represents the ratio of the crystal length (L) (or the maximal particle size of the crystal), corresponding to the longest dimension of the crystal, to its diameter or width or thickness (D), corresponding to the smallest dimension of the crystal measured at the middle of the long dimension, perpendicular to said long dimension (shortest dimension orthogonal to the long dimension). The aspect ratio (L/D) of the particles as well as the percentage (as vol %) of particles having a certain aspect ratio can be determined by image analysis, for example, of scanning electron microscopy (SEM) micrographs, e.g., using ImageJ software.

In a third aspect, the present disclosure therefore relates to a molecular sieve of DON framework type, e.g., UTD-1 or EMM-57 materials, whether in as-synthesized or calcined form, wherein at least a portion of the molecular sieve crystals have an aspect ratio (L/D) of at most 10, in particular less than 10, more particularly less than 8, such as from 1 to 6 or from 2 to 5, e.g., about 1, 2, 3 or 4, as determined by scanning electron microscopy (SEM).

Said molecular sieve may have an irregular shape (morphology) or may have an elongated morphology and may possibly be grouped in the form of secondary particles, aggregates or bundles. By “elongated morphology” is meant crystals that are substantially in the form of elongated particles such as rods, cylinders, sticks, laths, or needles.

The molecular sieve of the third aspect of the present disclosure, whether in as-synthesized or calcined form, may have a maximal particle size, defined as the longest dimension (or length) of the particle (or crystal or crystallite), of less than 1 micron, such as less than 500 nm, or less than 300 nm, or even less than 250 nm, as determined by scanning electron microscopy (SEM).

In a further or another embodiment, at least a portion of the molecular sieve of the present disclosure, whether in as-synthesized or calcined form, is in the form of small crystals having a maximal particle size of less than 250 nm, in particular less than 200 nm, or less than 100 nm, such as from 50 or 75 to less than 200 or 100 nm. By “at least a portion” is meant at least about 50% of the molecular sieve particles (or crystals), such as at least 60%, at least 75%, or at least 85%. The maximal particle size of a crystal corresponds to the longest dimension (or length) of the crystal. The maximal particle size of the crystals as well as the percentage (as vol %) of particles having a certain maximal size can be determined by image analysis, for example, of scanning electron microscopy (SEM) micrographs, e.g., using ImageJ software.

In a still further or another embodiment, the molecular sieve of the present disclosure, whether in as-synthesized or calcined form, may have an average maximal particle size of less than 250 nm, particularly less than 200 nm, or less than 100 nm, e.g., from 50 or 75 nm to less than 200or 100 nm. The average maximal particle size can be defined as the average (or arithmetic mean) of the longest dimension (or length) of particles measured from randomly selected SEM micrographs from which were selected at least one hundred particles.

In a fourth aspect, the present disclosure therefore relates to a molecular sieve of DON framework type, e.g., UTD-1 or EMM-57 materials, whether in as-synthesized or calcined form, having a maximal particle size and/or an average maximal particle size of less than 250 nm, in particular less than 200 nm, or less than 100 nm, such as from 50 or 75 to less than 200 or 100 nm, as determined by scanning electron microscopy (SEM).

In one or more further embodiments, the molecular sieve of the present disclosure, in its calcined form, may have a micropore volume of 0.05 to 0.3 cm³/g, such as 0.1 to 0.2 cm³/g, e.g., around 0.14 or 0.15 cm³/g, an external surface area of 50 to 500 m²/g, such as from 100 to 400 m²/g, e.g., from 150 to 300 m²/g, and/or a BET surface area of from 200 to 1000 m²/g, or from 300 to 800 m²/g, such as from 400 to 700 m²/g, e.g., from 500 to 600 m²/g.

The molecular sieve material of the present disclosure, in particular according to the second, third or fourth aspect of the present disclosure, may have, in its as-synthesized form (e.g., where the SDA has not been removed) and/or calcined form (e.g., where at least part of the SDA has been removed), X-ray diffraction (XRD) patterns similar to those of UTD-1 or EMM-57 materials. For instance, calcined aluminosilicate and borosilicate forms of said molecular sieves may have XRD patterns similar to those disclosed in U.S. Pat. No. 6,103,215A, incorporated herewith by reference and reproduced below in Table 1, while as-synthesized aluminosilicate and borosilicate forms of said molecular sieves may have XRD patterns similar to those disclosed in

WO2020/072157A1, incorporated herewith by reference and listed below in Table 2.

TABLE 1

| | d-spacing | Relative intensity |
|---|---|---|
| Degree 2-theta | (Å) | [100 × I/(Io)] |
| 6.0 ± 0.1 | 14.4-15.0 | >60 |
| 7.6 ± 0.1 | 11.5-11.8 | 40-60 |
| 14.55 ± 0.15 | 6.0-6.1 | <10-40 |
| 19.8 ± 0.1 | 4.4-4.5 | 10-40 |
| 21.2 ± 0.1 | 4.17-4.21 | >60 |
| 22.0 ± 0.1 | 4.01-4.06 | 10-40 |
| 22.5 ± 0.1 | 3.92-3.96 | 10-40 |
| 24.5 ± 0.05 | 3.64-3.68 | <10 |

TABLE 2

| Degree 2-theta | Degree 2-theta |
|---|---|
| of borosilicate form | of aluminosilicate form |
| 6.0 ± 0.12 | 6.0 ± 0.12 |
| 7.6 ± 0.1 | 7.6 ± 0.15 |
| 14.66 ± 0.15 | 14.55 ± 0.15 |
| 19.7 ± 0.15 | 19.64 ± 0.15 |
| 21.27 ± 0.15 | 21.01 ± 0.20 |
| 22.13 ± 0.15 | 21.90 ± 0.20 |
| 22.61 ± 0.15 | 22.34 ± 0.20 |
| 24.42 ± 0.10 | 24.38 ± 0.20 |

The molecular sieve material of the present disclosure, in particular according to the second, third or fourth aspect of the present disclosure, where part or all of the SDA has been removed, may be used as an adsorbent or as a catalyst or support for catalyst in a wide variety of hydrocarbon conversions, e.g., conversion of organic compounds to a converted product. In a fifth aspect, the present disclosure therefore relates to a process of converting an organic compound to a conversion product, which comprises contacting the organic compound with the molecular sieve according to the second or third aspect of the present disclosure.

The molecular sieve materials of the present disclosure (where part or all of the SDA is removed) may be used as an adsorbent, such as for separating at least one component from a mixture of components in the vapor or liquid phase having differential sorption characteristics with respect to the material. Therefore, at least one component can be partially or substantially totally separated from a mixture of components having differential sorption characteristics with respect to the molecular sieve by contacting the mixture with said molecular sieve to selectively sorb the one component. For instance, in a process for selectively separating one or more desired components of a feedstock from remaining components of the feedstock, the feedstock may be contacted with a sorbent that comprises the molecular sieve of the present disclosure at effective sorption conditions, thereby forming a sorbed product and an effluent product. One or more of the desired components are recovered from either the sorbed product or the effluent product.

The molecular sieve of the present disclosure (where part or all of the SDA is removed) may also be used as a catalyst to catalyze a wide variety of organic compound conversion processes. Examples of chemical conversion processes, which are effectively catalyzed by the molecular sieve described herein, cither alone or in combination with one or more other catalytically active substances including other crystalline catalysts, include those requiring a catalyst with acid activity. Examples of organic conversion processes, which may be catalyzed by the molecular sieve described herein, either alone or in combination with one or more other catalytically active substances, including other crystalline catalysts, include cracking, hydrocracking, isomerization, reforming, hydrogenation, dehydrogenation, dewaxing, hydrodewaxing, adsorption, alkylation, transalkylation, dealkylation, hydrodecylization, disproportionation, oligomerization, dehydrocyclization, conversion of methanol to olefins, conversion of ethanol to fuels, and combinations thereof. The conversion of hydrocarbon feeds can take place in any convenient mode, for example in fluidized bed, moving bed, or fixed bed reactors depending on the types of process desired.

The molecular sieve of the present disclosure may be formulated into product compositions by combination with other materials, such as binders and/or matrix materials that provide additional hardness to the finished product. These other materials can be inert or catalytically active materials.

For instance, it may be desirable to incorporate the molecular sieve of the present disclosure with another material that is resistant to the temperatures and other conditions employed during use. Such materials include synthetic or naturally occurring zeolites as well as inorganic materials such as clays, silica and/or metal oxides such as alumina and mixtures thereof. The metal oxides may be either naturally occurring or in the form of gelatinous precipitates or gels including mixtures of silica and metal oxides. Use of a resistant material in conjunction with the molecular sieve of the present disclosure, i.e., combined therewith or present during synthesis of the as-made molecular sieve, which crystal is active, tends to change the conversion and/or selectivity of the catalyst in certain organic conversion processes. Inactive resistant materials suitably serve as diluents to control the amount of conversion in a given process so that products can be obtained in an economic and orderly manner without employing other means for controlling the rate of reaction. These materials may be incorporated into naturally occurring clays, e.g., bentonite and kaolin, to improve the crush strength of the product under commercial operating conditions. Said inactive resistant materials, i.e., clays, oxides, etc., function as binders for the catalyst. A catalyst having good crush strength can be beneficial because in commercial use, it is desirable to prevent the catalyst from breaking down into powder-like materials.

Naturally occurring clays which may be used include the montmorillonite and kaolin family, which families include the subbentonites, and the kaolins commonly known as Dixie, McNamee, Georgia and Florida clays or others in which the main mineral constituent is halloysite, kaolinite, dickite, nacrite, or anauxite. Such clays can be used in the raw state as originally mined or after being subjected to calcination, acid treatment or chemical modification. Binders useful for compositing with the molecular sieve of the present disclosure also include inorganic oxides selected from silica, zirconia, titania, magnesia, beryllia, alumina, yttria, gallium oxide, zinc oxide and mixtures thereof.

In addition to the foregoing materials, the molecular sieve of the present disclosure may be composited with a porous matrix material such as silica-alumina, silica-magnesia, silica-zirconia, silica-thoria, silica-beryllia, silica-titania as well as ternary compositions such as silica-alumina-thoria, silica-alumina-zirconia, silica-alumina-magnesia and silica-magnesia-zirconia.

These binder materials are resistant to the temperatures and other conditions, e.g., mechanical attrition, which occur in various hydrocarbon separation processes. Thus, the molecular sieve of the present disclosure may be used in the form of an extrudate with a binder. They are typically bound by forming a pill, sphere, or extrudate. The extrudate is usually formed by extruding the molecular sieve, optionally in the presence of a binder, and drying and calcining the resulting extrudate. Further treatments such as steaming, and/or ion exchange may be carried out as required. The molecular sieve may optionally be bound with a binder having a surface area of at least 100 m²/g, for instance at least 200 m²/g, optionally at least 300 m²/g.

The relative proportions of molecular sieve and inorganic oxide matrix may vary widely, with the molecular sieve content ranging from about 1 to about 100 percent by weight and more usually, particularly when the composite is prepared in the form of extrudates, in the range of about 2 to about 95, optionally from about 20 to about 90 weight percent of the composite.

The molecular sieve of the present disclosure may also be used in intimate combination with a hydrogenating component such as tungsten, vanadium, molybdenum, rhenium, nickel, cobalt, chromium, manganese, or a noble metal such as platinum or palladium where a hydrogenation-dehydrogenation function is to be performed. Such hydrogenating components may be incorporated in the composition by way of one or more of the following processes: cocrystallization; exchanged into the composition to the extent a Group IIIA clement, e.g., aluminum, is in the structure; or intimately physically admixed therewith. Such components can also be impregnated in or onto the molecular sieve, for example, by treating the molecular sieve with a hydrogenating metal-containing ion. For instance, in the case of platinum, suitable platinum compounds for this purpose include chloroplatinic acid, platinous chloride and various compounds containing a platinum amine complex. Combinations of metals and methods for their introduction can also be used.

It will be understood by a person skilled in the art that the molecular sieve of the present disclosure may contain impurities, such as amorphous materials, unit cells having different topologies (e.g., quartz or molecular sieves of different framework type, that may or may not impact the performance of the resulting catalyst), and/or other impurities (e.g., heavy metals and/or organic hydrocarbons). Typical examples of molecular sieves of different framework type co-existing with the molecular sieve of the present disclosure are e.g., molecular sieves of FAU, IWV, FER, MOR framework type, such as undissolved Faujasite zeolite, ITQ-27, Ferrierite or Mordenite, or unknown layer phase. The molecular sieve of the present disclosure is preferably substantially free of impurities. The term “substantially free of impurities” (or in the alternative “substantially pure”)used herein means the molecular sieve material contains a minor proportion (less than 50 wt %), preferably less than 20 wt %, more preferably less than 10 wt %, even more preferably less than 5 wt % and most preferably less than 1 wt % (e.g., less than 0.5 wt % or 0.1 wt %), of such impurities (or “non-DON” framework type), which weight percent (wt %) values are based on the combined weight of impurities and pure molecular sieve. The amount of impurities can be appropriately determined by powder XRD, rotating electron diffraction, and/or SEM/TEM (e.g., different crystal morphologies).

The molecular sieve described herein is substantially crystalline. As used herein, the term “crystalline” refers to a crystalline solid form of a material, including, but not limited to, a single-component or multiple-component crystal form, e.g., including solvates, hydrates, and a co-crystal. Crystalline can mean having a regularly repeating and/or ordered arrangement of molecules, and possessing a distinguishable crystal lattice. For example, the molecular sieve can have different water or solvent content. The different crystalline lattices can be identified by solid state characterization methods such as by XRD (e.g., powder XRD). Other characterization methods known to a person of ordinary skill in the relevant art can further help identify the crystalline form as well as help determine stability and solvent/water content. As used herein, the term “substantially crystalline” means a majority (greater than 50 wt %) of the weight of a sample of a material described is crystalline and the remainder of the sample is a non-crystalline form. In one or more aspects, a substantially crystalline sample has at least 95% crystallinity (e.g., 5% of the non-crystalline form), at least 96% crystallinity (e.g., 4% of the non-crystalline form), at least 97% crystallinity (e.g., 3% of the non-crystalline form), at least 98% crystallinity (e.g., about 2% of the non-crystalline form), at least 99% crystallinity (e.g., 1% of the non-crystalline form), and 100% crystallinity (e.g., 0% of the non-crystalline form).

Aspects of the disclosure are described in greater detail by way of specific examples. The following examples are offered for illustrative purposes and are not intended to limit the disclosure in any manner. Those of skill in the relevant art will readily recognize a variety of parameters can be changed or modified to yield essentially the same results.

### EXAMPLES

The present invention is further illustrated below without limiting the scope thereto.

In these examples, the X-ray diffraction (XRD) patterns of the as-synthesized and calcined materials were recorded on a Bruker D8 Endeavor Automated X-ray Powder Diffractometer in continuous mode using a Cu Kα radiation, Bragg-Bentano geometry with Vantec 500 detector, in the 20 range of 4 to 50 degrees. The interplanar spacings, d-spacings, were calculated in Angstrom units, and the relative intensities of the lines, I/Io is the ratio of the peak intensity to that of the intensity of the strongest line, above background. The intensities arc uncorrected for Lorentz and polarization effects. The location of the diffraction peaks in 2-theta, and the relative peak area intensities of the lines, I/I (o), where Io is the intensity of the strongest line, above background, were determined with the MDI Jade peak search algorithm. It should be understood that diffraction data listed as single lines may consist of multiple overlapping lines which under certain conditions, such as differences in crystallographic changes, may appear as resolved or partially resolved lines. Typically, crystallographic changes can include minor changes in unit cell parameters and/or a change in crystal symmetry, without a change in the framework connectivity. These minor effects, including changes in relative intensities, can also occur as a result of differences in cation content, framework composition, nature and degree of pore filling, crystal size and shape, preferred orientation and thermal and/or hydrothermal history.

The scanning electron microscopy (SEM) images of the as-synthesized materials were obtained on a Hitachi S4800 field emission scanning electron microscope. SEM images were used to aid assessment of product purity. The presence of obviously different crystal morphologies in a SEM image can be an indication of impurities in the form of other crystalline materials. Such an approximate analysis can be especially useful in identifying the presence of formation of relatively minor amounts of crystalline impurities which may not be identifiable on product XRD patterns.

The following measurements were conducted on samples that were calcined at 500° C. for 16 hours. The sample were subjected to ion-exchange before calcination, by washing the as-prepared sample twice with a IM ammonium nitrate solution.

The overall BET surface area (S_{BET}) of the materials was determined by the BET method as described by S. Brunauer, P. H. Emmett and E. Teller, J. Am. Chem. Soc., 1938, 60, 309, incorporated herein by reference, using nitrogen adsorption-desorption at liquid nitrogen temperature. The external surface area (Sₑₓₜ) of the material was obtained from the t-plot method.

The micropore volume (V_{micro}) and total pore volume (Vₜₒₜₐₗ) of the materials can be determined using methods known in the relevant art. For example, the micropore and total pore volumes of the materials can be measured with nitrogen physisorption, and the data can be analyzed by the t-plot method described in Lippens, B. C. et al., “Studies on pore system in catalysts: V. The t method”, J. Catal., 4, 319 (1965), which describes micropore and total pore volume methods and is incorporated herein by reference.

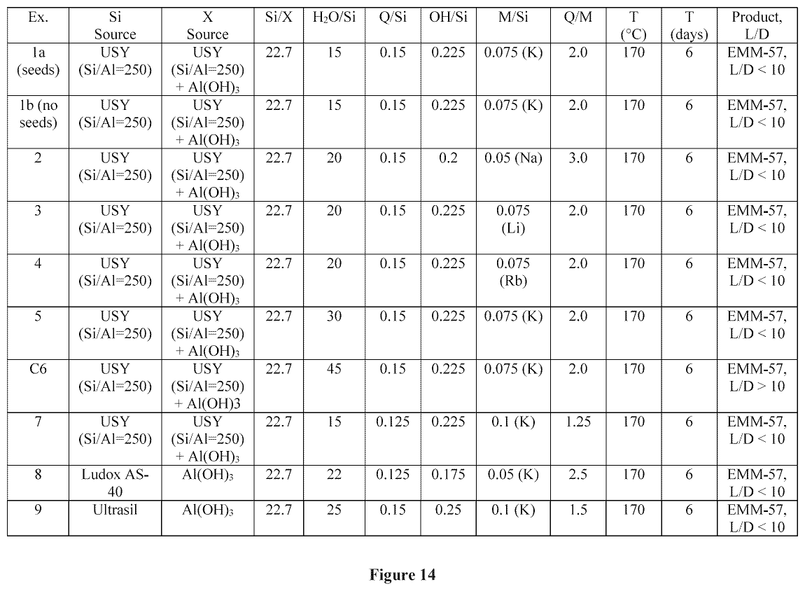

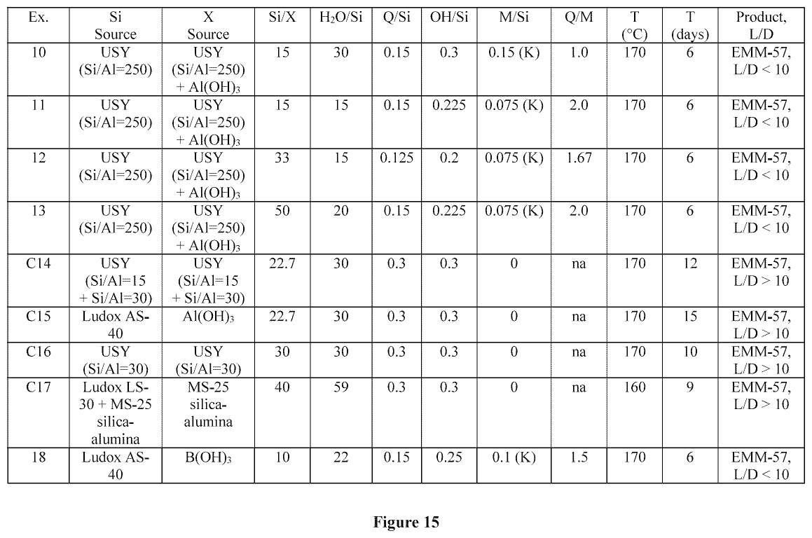

The molar ratios and conditions used for the syntheses of Examples 1a/1b-18, as well as the resulting products, are detailed below and summarized in FIG. 14 and FIG. 15. FIG. 14 contains the molar ratios, conditions, and resulting products for Examples 1a, 1b, and 2-9. FIG. 15 contains the molar ratios, conditions, and resulting products for Examples 10-18.

### Example 1a: Synthesis of Aluminosilicate EMM-57 with Si/Al=22.7

In a PTFE liner for a 45-mL Steel Parr autoclave, the following were mixed together: 16.2 g of 1,2,3-trimethylbenzimidazolium hydroxide (QOH) solution (9.5 wt %), 3.45 g of a USY (Faujasite) zeolite with a Si/Al molar ratio of 250 (available from Tosoh as HSZ-390HUA), 1.21 g of a potassium hydroxide solution (KOH, 20 wt %), 0.17 g of Al(OH)₃ (Alfa, 76 wt %), and about 1-2 wt % seeds of DON framework type, based on the total weight of the synthesis mixture. The resulting synthesis mixture had the following composition in terms of molar ratios:
1SiO₂:0.022 Al₂O₃:0.15 QOH:0.075 KOH:15 H₂O

The liner was then capped, sealed within a 45-mL Parr autoclave, and placed within a spit inside of a convection oven. The reactor was heated at 170° C. for 6 days under tumbling conditions (˜40 rpm). The product was isolated by filtration, rinsed with deionized water, and dried.

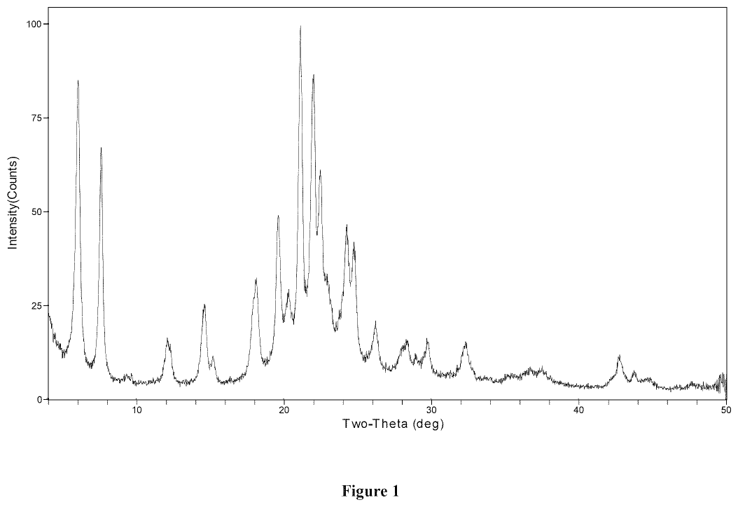

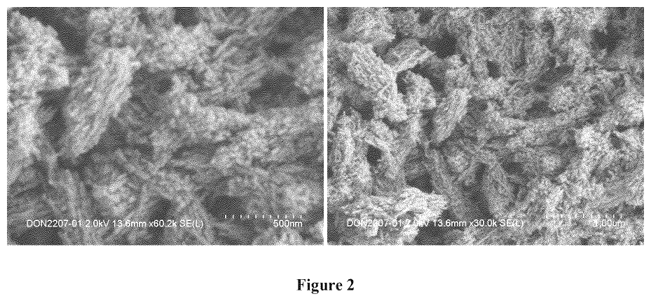

FIG. 1 shows the powder XRD pattern of the as-synthesized product of Example 1a, which is characteristic of an aluminosilicate of DON framework type. The product of Example 1a was identified as an aluminosilicate EMM-57 material. FIG. 2 are SEM images of the as-synthesized product of Example 1a, illustrating that the product was in the form of agglomerates of small particles of irregular shape or morphology, having an (average) maximal particle size of less than 100 nm and an aspect ratio (L/D) smaller than 10, in particular smaller than 3.

### Example 1b: Synthesis of Aluminosilicate EMM-57 with Si/Al=22.7 (No Seeds)

Example 1b was conducted in similar conditions as Example 1a, except for the absence of seeds. In a PTFE liner for a 23-mL Steel Parr autoclave, the following were mixed together: 2.96 g of 1,2,3-trimethylbenzimidazolium hydroxide (QOH) solution (9.5 wt %), 0.69 g of a USY (Faujasite) zeolite with a Si/Al molar ratio of 250 (available from Tosoh as HSZ-390HUA), 0.24 g of a potassium hydroxide solution (KOH, 20 wt %), and 0.034 g of Al(OH)₃ (Alfa, 76 wt %). The resulting synthesis mixture had the following composition in terms of molar ratios:
1 SiO₂:0.022 Al₂O₃:0.15 QOH:0.075 KOH:15 H₂O

The liner was then capped, sealed within a 23-mL Parr autoclave, and placed within a spit inside of a convection oven at 170° C. for 6 days under tumbling conditions (˜40 rpm). The product was isolated by filtration, rinsed with deionized water, and dried.

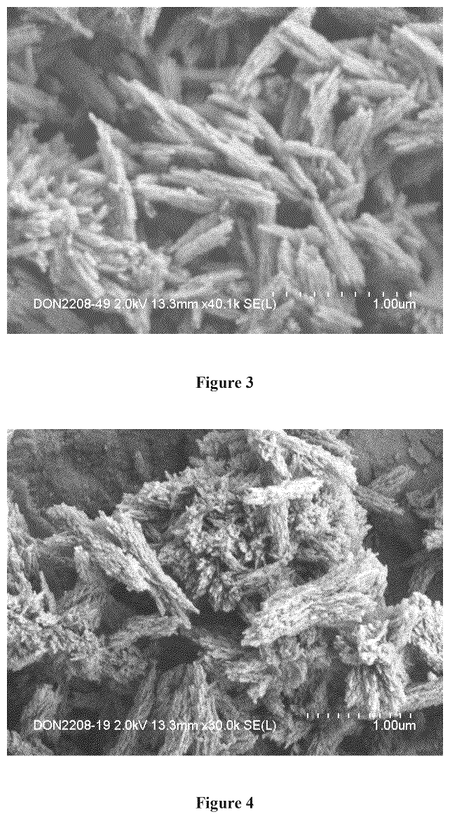

The product of Example 1b was identified as an aluminosilicate EMM-57 material on the basis of its XRD pattern. FIG. 3 is a SEM image of the as-synthesized product of Example 1b, illustrating that the product was in the form of agglomerates of small particles of irregular shape or morphology, having an (average) maximal particle size of less than 150 nm and an aspect ratio (L/D) smaller than 10.

### Examples 2-4: Synthesis of Aluminosilicate EMM-57 in the Presence of Na, Li or Rb

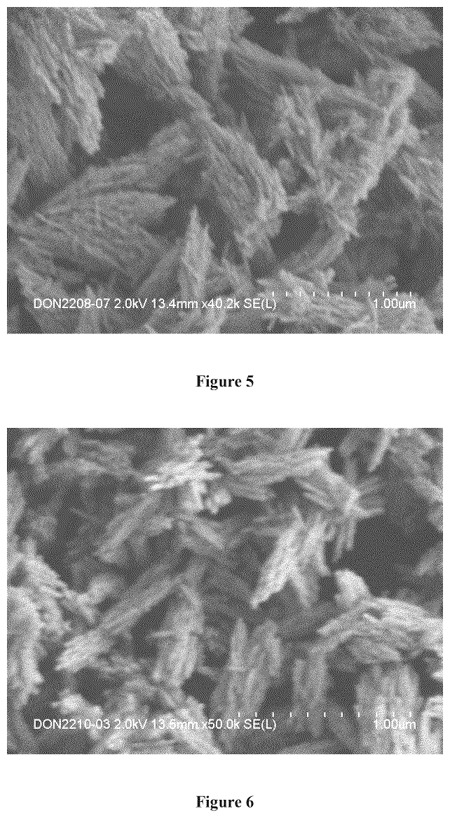

Examples 2 to 4 illustrate the preparation of EMM-57 in the presence of sodium hydroxide, lithium hydroxide or rubidium hydroxide as replacement to potassium hydroxide. The detailed synthesis mixture compositions and conditions are provided in FIG. 14. The products of Examples 2 to 4 were identified as aluminosilicate EMM-57 materials on the basis of their XRD patterns. Analysis by SEM showed the product of Examples 2-4 to be in the form of agglomerates of small crystals having an (average) maximal particle size of less than 200 nm or less than 100 nm and an aspect ratio (L/D) lower than 10, as illustrated by, e.g., FIG. 4 for Example 2 and FIG. 5 for Example 4.

### Example 5 and Comparative Example 6: Effect of the H₂O:Si Molar Ratio on the Synthesis of EMM-57

Example 5 and Comparative Example 6 illustrate the preparation of EMM-57 from synthesis mixtures comprising higher water amounts as compared to Example 1a (i.e., H₂O:Si of respectively 30 and 45 as compared to 15) and illustrate the effect of the water to silica molar ratio on the aspect ratio of the resulting EMM-57 materials. While the products of Example 5 and Comparative Example 6 were both identified as aluminosilicate EMM-57 on the basis of their XRD patterns, analysis by SEM showed that the aspect ratio (L/D) of the material of Example 5 was lower than 10 while the aspect ratio (L/D) of the material of Comparative Example 6 was higher than 10.

### Example 7: Synthesis of Aluminosilicate EMM-57 with Varying SDA and K Amounts

Example 7 illustrates the preparation of EMM-57 from a synthesis mixture comprising a lower amount of SDA (QOH) and a higher amount of potassium. The detailed synthesis mixture composition and conditions are provided in FIG. 14. The product of Example 7 was identified as aluminosilicate EMM-57 on the basis of its XRD pattern. Analysis by SEM showed the product of Example 7 to have an aspect ratio (L/D) lower than 10.

### Examples 8 and 9: Synthesis of Aluminosilicate EMM-57 with Varying Si Sources

Examples 8 and 9 illustrate the preparation of EMM-57 using different Si sources, i.e., respectively Ludox AS-40 (40 wt % colloidal silica suspension) and Ultrasil (precipitated silica). The detailed synthesis mixture compositions and conditions are provided in FIG. 14. The products of Examples 8 and 9 were identified as aluminosilicate EMM-57 materials on the basis of their XRD patterns. Analysis by SEM showed the products of Examples 8 and 9 to be in the form of agglomerates of small crystals having an (average) maximal particle size of less than 100 nm and an aspect ratio (L/D) lower than 10, as illustrated by, e.g., FIG. 6 for Example 9.

### Examples 10: Synthesis of Aluminosilicate EMM-57 with Si/Al=15

In a PTFE liner for a 23-mL Steel Parr autoclave, the following were mixed together: 3.23 g of 1,2,3-trimethylbenzimidazolium hydroxide (QOH) solution (9.5 wt %), 0.99 g of a USY (Faujasite) zeolite with a Si/Al molar ratio of 250 (available from Tosoh as HSZ-390HUA), 0.48 g of a potassium hydroxide solution (KOH, 20 wt %), 0.051 g of Al(OH)₃ (Alfa, 76 wt %), 2.88 g of water and about 1-2 wt % seeds of DON framework type, based on the total weight of the synthesis mixture. The resulting synthesis mixture had the following composition in terms of molar ratios:
1 SiO₂:0.033 Al₂O₃:0.15 QOH:0.15 KOH:30 H₂O

The liner was then capped, sealed within a 23-mL Parr autoclave, and placed within a spit inside of a convection oven. The reactor was heated at 170° C. for 6 days under tumbling conditions (˜ 40 rpm). The product was isolated by filtration, rinsed with deionized water, and dried and was identified as an aluminosilicate EMM-57 material on the basis of its XRD pattern. Analysis by SEM showed the products of Example 10 to be in the form of agglomerates

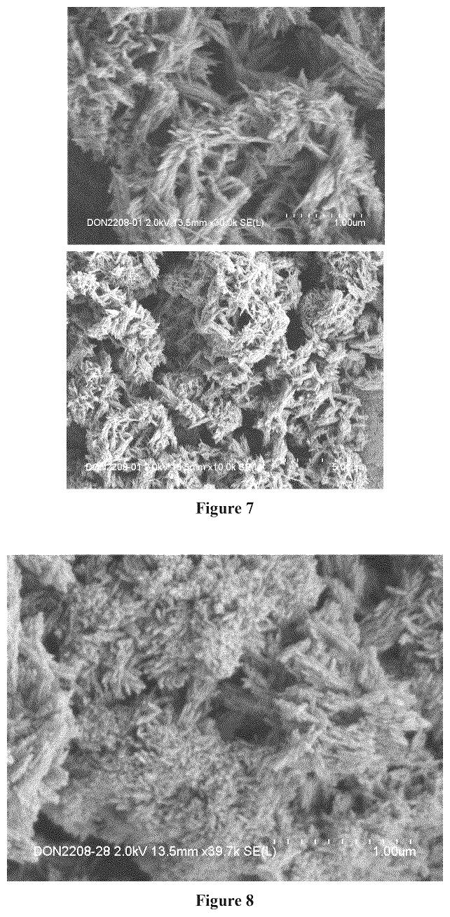

of small crystals having an (average) maximal particle size of about 300 to 500 nm and an aspect ratio (L/D) lower than 10, as illustrated by FIG. 7.

The total BET surface area (SBET) of the calcined version of the EMM-57 material of Example 10 was 509 m²/g, its external surface area (Sₑₓₜ) was 167 m²/g, its total pore volume (Vₜₒₜₐₗ) was 0.7 cm³/g, and its micropore volume (V_{micro}) was 0.14 cm³/g.

### Examples 11: Synthesis of Aluminosilicate EMM-57 with Si/Al=15

Example 11 was conducted in similar conditions to Example 10 except for lower amounts of water and potassium hydroxide, resulting in a synthesis mixture having the following composition in terms of molar ratios:
1 SiO₂:0.033 Al₂O₃:0.15 QOH:0.075 KOH:15 H₂O

After 6 days of heating at 170° C., pure EMM-57 material was obtained, as identified by its XRD pattern. Analysis by SEM showed the as-synthesized product of Example 11 to be in the form of agglomerates of small crystals having an (average) maximal particle size of less than 100 nm and an aspect ratio (L/D) lower than 10, as illustrated by FIG. 8.

### Examples 12-13: Synthesis of aluminosilicate EMM-57 with Si/Al=33 or Si/Al=50

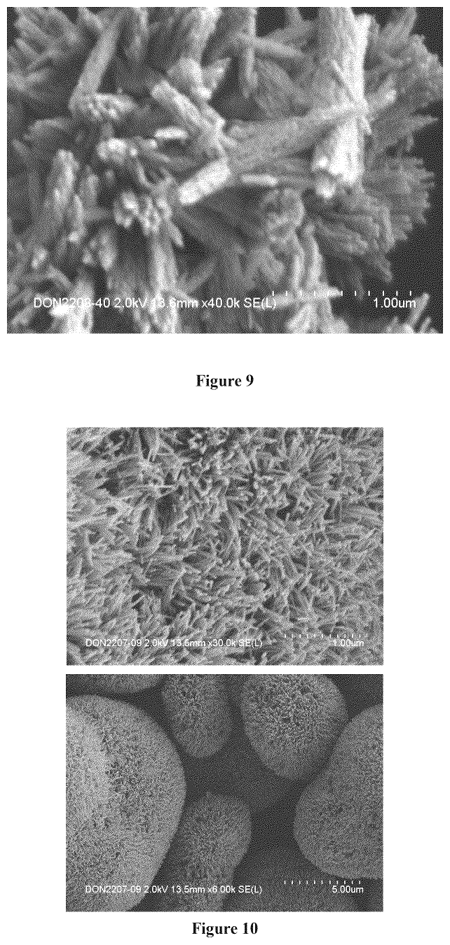

Examples 12 and 13 illustrate the preparation of EMM-57 from a synthesis mixture having a Si/Al content of respectively 33 or 50. The detailed synthesis mixture compositions and conditions are provided in FIG. 15. The products of Examples 12 and 13 were identified as aluminosilicate EMM-57 materials on the basis of their XRD patterns. Analysis by SEM showed the products of Examples 12 and 13 to be in the form of agglomerates of small crystals having an (average) maximal particle size of less than 200 nm and an aspect ratio (L/D) lower than 10, as illustrated by, e.g., FIG. 9 for Example 13.

### Comparative Example 14: Synthesis of Aluminosilicate EMM-57 with Si/Al=22.7 in the Absence of Alkali and Alkaline Earth Metals

Example 14 illustrates the preparation of EMM-57 in the absence of alkali and alkaline earth metals. In a PTFE liner for a 45-mL Steel Parr autoclave, the following were mixed together: 20.92 g of 1,2,3-trimethylbenzimidazolium hydroxide (QOH) solution (9.5 wt %), 1.26 g of USY zeolite with Si/Al molar ratios of 15 (available from Zeolyst as CBV720), 1.26 g of USY zeolite with Si/Al molar ratios of 30 (available from Zeolyst as CBV760), 0.89 g of water and about 1-2 wt % seeds of DON framework type, based on the total weight of the synthesis mixture. The resulting synthesis mixture had the following composition in terms of molar ratios:
1 SiO₂:0.022 Al₂O₃:0.3 QOH:30 H₂O

The liner was then capped, sealed within a 45-mL Parr autoclave, and placed within a spit inside of a convection oven. The reactor was heated at 170° C. for 12 days under tumbling conditions (˜40 rpm). The product was isolated by filtration, rinsed with deionized water, and dried and was identified as an aluminosilicate EMM-57 material on the basis of its XRD pattern.

Analysis by SEM showed the product of Example 14 to be in the form of agglomerates of long crystals (needles) having an (average) maximal particle size of larger than 1 micron and an aspect ratio (L/D) significantly higher than 10, as illustrated by FIG. 10.

The total BET surface area (SBET) of the calcined version of the EMM-57 material of Example 12 was 573 m²/g, its external surface area (Sₑₓₜ) was 195 m²/g, its total pore volume (Vₜₒₜₐₗ) was 0.76 cm³/g, and its micropore volume (V_{micro}) was 0.15 cm³/g.

### Comparative Example 15: Synthesis of Aluminosilicate EMM-57 with Si/Al=22.7 in the Absence of Alkali and Alkaline Earth Metals

Example 15 was conducted in the same conditions as Example 14, except that the Si and Al sources were replaced with respectively Ludox AS-40 (40 wt % colloidal silica suspension) and Al(OH)₃ (Alfa, 76 wt %). After 15 days of heating at 170° C., aluminosilicate EMM-57 product was obtained, as identified by its XRD pattern. Analysis by SEM showed the product of Comparative Example 15 to have an aspect ratio (L/D) significantly higher than 10.

### Comparative Example 16: Synthesis of aluminosilicate EMM-57 with Si/Al=30 in the Absence of Alkali and Alkaline Earth Metals

Comparative Example 16 was conducted in similar conditions as Comparative Example 14, except for different Si/Al molar ratios, using USY (Faujasite) zeolites with Si/Al molar ratios of 30 (available from Zeolyst as CBV360) as the Si and Al sources. After 10 days of heating at 170° C., aluminosilicate EMM-57 product was obtained, as identified by its XRD pattern. Analysis by SEM showed the product of Comparative Example 16 to have an aspect ratio (L/D) significantly higher than 10.

### Comparative Example 17: Synthesis of Aluminosilicate EMM-57 (or UTD-1) with Si/Al=40 in the Absence of Alkali and Alkaline Earth Metals

In a PTFE liner for a 23-mL Steel Parr autoclave, the following were mixed together: 9.9 g of 1,2,3-trimethylbenzimidazolium hydroxide (QOH) solution (10 wt %), 3.28 g of Ludox LS-30 (30 wt % colloidal silica suspension), 0.104 g of MS-25 silica-alumina mixture (66.5% silica-22% a lumina), 2.24 g of deionized water, and about 1-2 wt % seeds of EMM-57 (or UTD-1) seeds obtained from a former synthesis, based on the total weight of the synthesis mixture. The resulting synthesis mixture had the following composition in terms of molar ratios:
1 SiO₂:0.0125 Al₂O₃:0.3 QOH:59 H₂O

The liner was then capped, sealed within a 23-mL Parr autoclave vessel. The autoclave vessel was then heated in a convection oven under tumbling conditions for 9 days at 160° C. The autoclave vessel was then removed from the oven and quenched by placing the autoclave vessel in a water bath to promote cooling. The product was isolated by filtration, washed with about 250 mL of deionized water, and dried in an oven at 95° C.

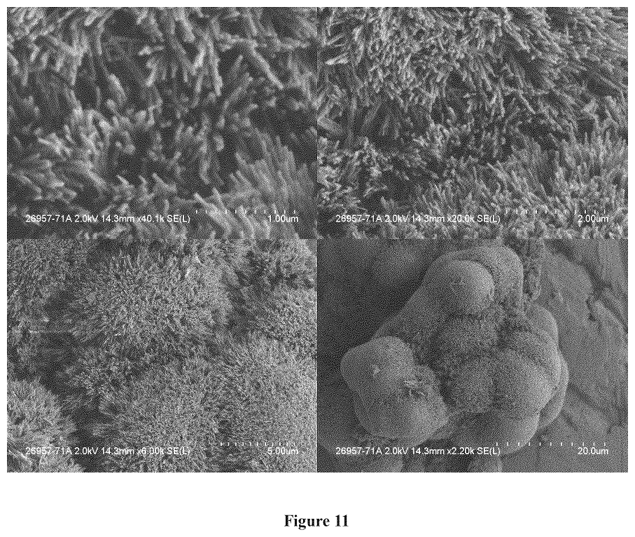

The product of Comparative Example 17 was identified as aluminosilicate UTD-1 (or EMM-57) material on the basis of its XRD pattern. FIG. 11 shows SEM images of the as-synthesized product of Comparative Example 17 at various magnifications. As shown, the UTD-1 (or EMM-57) produced in Comparative Example 17 was in the form of bundles or agglomerates of needles or laths of approximately 250-500 nm in length, having an aspect ratio (L/D) significantly higher than 10.

### Example 18: Synthesis of Borosilicate EMM-57 with Si/B=10

In a PTFE liner for a 23-mL Steel Parr autoclave, the following were mixed together: 2.96 g of 1,2,3-trimethylbenzimidazolium hydroxide (QOH) solution (9.5 wt %), 1.58 g of Ludox AS-40 (40 wt % colloidal silica suspension), 0.29 g of a potassium hydroxide solution (KOH, 20 wt %), 0.065 g of B(OH)₃ (Sigma, 100%), and about 1-2 wt % seeds of DON framework type, based on the total weight of the synthesis mixture. The resulting synthesis mixture had the following composition in terms of molar ratios:
1 SiO₂:0.05 B₂O₃:0.15 QOH:0.1 KOH:22 H₂O

The liner was then capped, sealed within a 23-mL Parr autoclave, and placed within a spit inside of a convection oven. The reactor was heated at 170° C. for 6 days under tumbling conditions (˜40 rpm). The product was isolated by filtration, rinsed with deionized water, and dried.

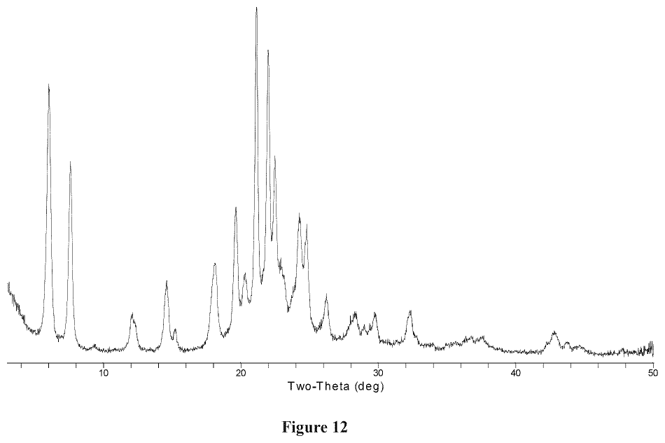

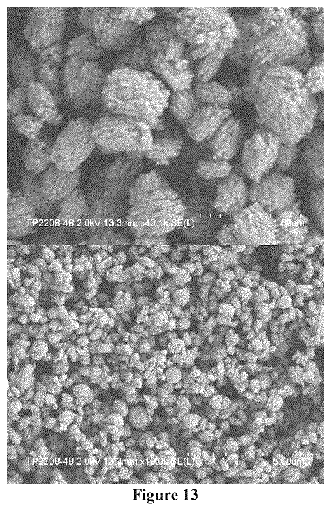

The product of Example 18 was identified as a borosilicate EMM-57 material on the basis of its XRD pattern, as illustrated by FIG. 12. FIG. 13 are SEM images of the as-synthesized product of Example 18, illustrating that the product was in the form of agglomerates of small particles of irregular shape or morphology, having an (average) maximal particle size of less than 100 nm and an aspect ratio (L/D) smaller than 10.

While the present invention has been described and illustrated with reference to particular embodiments, it will be appreciated by those of ordinary skill in the art that the invention lends itself to many different alterations, modifications, and variations not specifically illustrated herein. It will also be apparent to those skilled in the art that when numerical lower limits and numerical upper limits are listed herein, ranges from any lower limit to any upper limit are contemplated. Also, all numerical values within the detailed description herein are modified by “about” the indicated value, and take into account experimental error and variations that would be expected by a person having ordinary skill in the art.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

Additionally or alternately, the invention relates to:

Embodiment 1: A method of making a molecular sieve of DON framework type comprising the steps of:
(a) preparing a synthesis mixture comprising water, a source of an oxide of tetravalent element (Y), a source of an oxide of trivalent element (X), a structure directing agent (Q) selected from 1,2,3-trimethylbenzimidazolium cations, a source of hydroxide ions (OH), and a source of alkali and/or alkaline earth metal element (M), wherein the synthesis mixture comprises water in a H₂O: Y molar ratio of less than 45;
(b) heating said synthesis mixture under crystallization conditions including a temperature of from 100 to 200° C. for a time sufficient to form crystals of said molecular sieve; and
(c) recovering at least a portion of the molecular sieve from step (b).

Embodiment 2: The method of embodiment 1 further comprising step (d) of treating the molecular sieve recovered in step (c) to remove at least part of the structure directing agent (Q).

Embodiment 3: The method of embodiment 1 or 2, wherein the structure directing agent (Q) is in the form of a halide, hydroxide or nitrate, preferably wherein the structure directing agent (Q) is in its hydroxide form.

Embodiment 4: The method of any one of the preceding embodiments, wherein the tetravalent element (Y) is selected from the group consisting of silicon, germanium, tin, titanium, zirconium, and mixtures thereof, preferably wherein the tetravalent element (Y) comprises silicon, more preferably wherein the tetravalent element (Y) is silicon.

Embodiment 5: The method of any one of the preceding embodiments, wherein the trivalent element (X) is selected from the group consisting of aluminium, boron, iron, gallium, and mixtures thereof, preferably wherein the trivalent element (X) comprises aluminum and/or boron, more preferably wherein the trivalent element (X) is aluminum and/or boron, in particular aluminum.

Embodiment 6: The method of any one of the preceding embodiments, wherein the synthesis mixture has the following composition in terms of molar ratios:

| Molar ratios | Typical range | Preferred range | More preferred range |
|---|---|---|---|
| Y/X | 5-100 | 10-100 | 10-50 |
| Q/Y | 0.01-1.0 | 0.05-0.5 | 0.1-<0.3 |
| OH/Y | 0.01-1.0 | 0.05-0.8 | 0.1-0.5 |
| M/Y | 0.01-1.0 | 0.02-0.5 | 0.03-0.3 |
| H₂O/Y | 1-<45 | 5-40 | 10-30 |

Embodiment 7: A molecular sieve of DON framework type obtainable by the method of any one of the preceding embodiments.

Embodiment 8: A molecular sieve of DON framework type having an aspect ratio (L/D) of at most 10.

Embodiment 9: The molecular sieve of embodiment 7 or 8, having a maximal particle size and/or an average maximal particle size of less than 1 micron, preferably less than 500 nm, more preferably less than 300 nm, most preferably less than 250 nm, as determined by scanning electron microscopy (SEM).

Embodiment 10: The molecular sieve of any one of embodiment 7 to 9, wherein the molecular sieve is in the form of particles having an irregular shape or an elongated morphology.

Embodiment 11: A molecular sieve of DON framework type having a maximal particle size and/or an average maximal particle size of less than 250 nm, as determined by scanning electron microscopy (SEM).

Embodiment 12: The molecular sieve of any one of embodiments 7 to 11, having an aspect ratio (L/D) from 1 to less than 10, preferably from 1 to less than 8, more preferably from 1 to 6, as determined by scanning electron microscopy (SEM).

Embodiment 13: The molecular sieve of any one of embodiments 7 to 12, wherein the molecular sieve has a maximal particle size and/or an average maximal particle size of less than 200 nm, preferably less than 100 nm, more preferably from 50 to less than 200 nm, most preferably from 50 to less than 100 nm, as determined by scanning electron microscopy (SEM).

Embodiment 14: The molecular sieve of any one of embodiments 7 to 13, wherein the molecular sieve has a X/Y molar ratio of from 5 to 100, preferably from 10 to 100.

Embodiment 15: The molecular sieve of any one of embodiments 7 to 14, wherein the molecular sieve is an aluminosilicate, an aluminoborosilicate, or a borosilicate molecular sieve, preferably an aluminosilicate or a borosilicate molecular sieve.

Embodiment 16: The molecular sieve of any one of embodiments 7 to 15, wherein the molecular sieve is UTD-1 or EMM-57 material.

Embodiment 17: A process of converting an organic compound to a conversion product, which comprises contacting the organic compound with the molecular sieve of any one of embodiments 7 to 16.

1. A method of making a molecular sieve of DON framework type comprising the steps of:
(a) preparing a synthesis mixture comprising water, a source of an oxide of tetravalent element (Y), a source of an oxide of trivalent element (X), a structure directing agent (Q) selected from 1,2,3-trimethylbenzimidazolium cations, a source of hydroxide ions (OH), and a source of alkali and/or alkaline earth metal element (M), wherein the synthesis mixture comprises water in a H₂O:Y molar ratio of less than 45;
(b) heating said synthesis mixture under crystallization conditions including a temperature of from 100 to 200° C. for a time sufficient to form crystals of said molecular sieve; and
(c) recovering at least a portion of the molecular sieve from step (b).

2. The method of claim 1, wherein the method further comprises:
(d) treating the molecular sieve recovered in step (c) to remove at least part of the structure directing agent (Q).

3. The method of claim 2, wherein the structure directing agent (Q) is in the form of a halide, hydroxide or nitrate.

4. The method of claim 2, wherein the structure directing agent (Q) is in its hydroxide form.

5. The method of claim 1, wherein the tetravalent element (Y) is selected from the group consisting of silicon, germanium, tin, titanium, zirconium, and mixtures thereof.

6. The method of claim 1, wherein the trivalent element (X) is selected from the group consisting of aluminium, boron, iron, gallium, and mixtures thereof.

7. The method of claim 1, wherein the tetravalent element (Y) comprises silicon, or wherein the trivalent element (X) comprises at least one of aluminum and boron, or a combination thereof.

8. The method of claim 1, wherein the synthesis mixture has the following composition in terms of molar ratios:

| Molar ratios | Range |
|---|---|
| Y/X | 5-100 |
| Q/Y | 0.01-1.0 |
| OH/Y | 0.01-1.0 |
| M/Y | 0.01-1.0 |
| H₂O/Y | 1-<45. |

9. The method of claim 1, wherein the synthesis mixture has the following composition in terms of molar ratios:

| Molar ratios | Range |
|---|---|
| Y/X | 10-100 |
| Q/Y | 0.05-0.5 |
| OH/Y | 0.05-0.8 |
| M/Y | 0.02-0.5 |
| H₂O/Y | 5-40. |

10. The method of claim 1, wherein the synthesis mixture has the following composition in terms of molar ratios:

| Molar ratios | Range |
|---|---|
| Y/X | 10-50 |
| Q/Y | 0.1-<0.3 |
| OH/Y | 0.1-0.5 |
| M/Y | 0.03-0.3 |
| H₂O/Y | 10-30. |

11. A molecular sieve of DON framework type having at least one of an aspect ratio (L/D) of at most 10, a maximal particle size of less than 250 nm, an an average maximal particle size of less than 250 nm, as determined by scanning electron microscopy (SEM).

12. The molecular sieve of claim 11, having an aspect ratio (L/D) of 1 to less than 8, as determined by scanning electron microscopy (SEM).

13. The molecular sieve of claim 11 having a maximal particle size and/or an average maximal particle size of 50 nm to less than 200 nm or from 50 to less than 100 nm, as determined by scanning electron microscopy (SEM).

14. The molecular sieve of claim 11 having a maximal particle size and/or an average maximal particle size of 50 nm to less than 100 nm, as determined by scanning electron microscopy (SEM).

15. The molecular sieve of claim 11, wherein the molecular sieve has a X/Y molar ratio of 5 to 100.

16. The molecular sieve of claim 11, wherein the molecular sieve is an aluminosilicate, an aluminoborosilicate, or a borosilicate molecular sieve.

17. The molecular sieve of claim 11, wherein the molecular sieve is UTD-1 or EMM-57 material.

18. A molecular sieve of DON framework type according to claim 11, wherein the molecular sieve is made by a method comprising the steps of:
a) preparing a synthesis mixture comprising water, a source of an oxide of tetravalent element (Y), a source of an oxide of trivalent element (X), a structure directing agent (Q) selected from 1,2,3-trimethylbenzimidazolium cations, a source of hydroxide ions (OH), and a source of alkali and/or alkaline earth metal element (M), wherein the synthesis mixture comprises water in a H₂O:Y molar ratio of less than 45;
b) heating said synthesis mixture under crystallization conditions including a temperature of from 100 to 200° C. for a time sufficient to form crystals of said molecular sieve; and
(c) recovering at least a portion of the molecular sieve from step (b).

19. A process of converting an organic compound to a conversion product, comprising contacting the organic compound with the molecular sieve of claim 11 under conversion conditions.
